(19) United States
(12) Patent Application Publication
(10) Pub. No.: US 2024/0145855 A1
(43) Pub. Date: May 2, 2024

(54) SECONDARY BATTERY

(71) Applicant: SAMSUNG SDI CO., LTD., Yongin-si (KR)

(72) Inventor: Young Deok KIM, Yongin-si (KR)

(21) Appl. No.: 18/476,005

(22) Filed: Sep. 27, 2023

(30) Foreign Application Priority Data
Oct. 31, 2022 (KR) 10-2022-0142331

(51) Int. Cl. H01M 50/367; H01M 50/30

(52) U.S. Cl. CPC H01M 50/367; H01M 50/394; H01M 10/052

(57) ABSTRACT

A secondary battery in which an internal gas is easily discharged to improve safety. The secondary battery includes an electrode assembly, a case accommodating the electrode assembly and including an opening, a plate coupled to the opening of the case and including a vent hole and a safety vent in the vent hole, and a cover coupled to the plate. The plate includes a number of gas discharge holes outside of the vent hole.

### CROSS-REFERENCE TO RELATED APPLICATION

This application claims priority to and the benefit of Korean Patent Application No. 10-2022-0142331 filed on Oct. 31, 2022, in the Korean Intellectual Property Office, the entire disclosure of which is incorporated herein by reference.

### BACKGROUND

### 1. Field

Embodiments relate to a secondary battery.

### 2. Description of the Related Art

Batteries may be classified into prismatic batteries, cylindrical batteries, pouch-type batteries, and the like depending on their shape. A prismatic or cylindrical battery may be manufactured by inserting an electrode assembly including a positive electrode, a negative electrode, and a separator into a metal case and then sealing the metal case. A pouch-type battery may be manufactured by wrapping an electrode assembly with aluminum foil coated with an insulating material.

The prismatic or cylindrical battery may be manufactured by assembling a cap assembly after inserting the electrode assembly into the case. In addition, the cap assembly may include a safety vent that is configured to rupture if a pressure of an internal gas is equal to or higher than a set pressure, and a vent hole through which the internal gas moves through the safety vent and is discharged outside of the secondary battery. The internal gas may be a high-temperature and high-pressure gas.

The above-described information disclosed in the technology that serves as the background of the present disclosure is only for improving understanding of the background of the present disclosure and thus may include information that does not constitute the related art.

### SUMMARY

Aspects of some embodiments of the present disclosure provide a secondary battery in which an internal gas is easily discharged to improve the safety of the secondary battery.

According to some embodiments, a secondary battery includes: an electrode assembly; a case accommodating the electrode assembly and including an opening; a plate coupled to the case at the opening and including a vent hole and a safety vent in the vent hole; and a cover coupled to the plate. The plate includes a number of gas discharge holes outside the vent hole.

Sizes of the gas discharge holes may gradually increase in a direction outward away from the vent hole.

The plate may further include a rib between the gas discharge holes.

The rib may include: a first rib extending in a longitudinal direction of the plate; and a number of second ribs perpendicular to the first rib and extending from the first rib toward a long side surface of the case.

The cover may include an insulating material.

The cover may be integral with the plate by injection molding.

The cover may include a center hole at a position corresponding to the vent hole.

The cover may include a gas collection part in a bottom surface of the cover.

The gas collection part may include: a base portion; and a protrusion protruding from the base portion.

The base portion may have a thickness less than that of the cover.

The protrusion may be coupled to the gas discharge holes.

The secondary battery may further include: a first terminal part electrically connected to a first electrode plate of the electrode assembly; and a second terminal part electrically connected to a second electrode plate of the electrode assembly. The first terminal part may be coupled to a first show side surface of the electrode assembly and the second terminal part may be coupled to a second short side surface of the electrode assembly.

The secondary battery may further include: a first terminal part electrically connected to a first electrode plate of the electrode assembly; and a second terminal part electrically connected to a second electrode plate of the electrode assembly. The first terminal part and the second terminal part may be coupled to the plate.

The cover may include: a first area inside the first terminal part and the second terminal part; and a second area outside the first terminal part and the second terminal part and separated from the first area.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 illustrates a perspective view of a secondary battery according to embodiments of the present disclosure;

FIG. 2 illustrates an exploded perspective view of the secondary battery according to embodiments of the present disclosure;

FIG. 3 illustrates a perspective view of a bottom surface of a cover illustrated in FIG. 2;

FIG. 4 illustrates a cross-sectional view taken along line A-A of FIG. 1;

FIG. 5 illustrates a perspective view of a secondary battery according to embodiments of the present disclosure;

FIG. 6 illustrates an exploded perspective view of the secondary battery according to embodiments of the present disclosure;

FIG. 7 illustrates a perspective view of a bottom surface of a cover illustrated in FIG. 6; and

FIG. 8 illustrates a cross-sectional view taken along line B-B of FIG. 5.

### DETAILED DESCRIPTION

Hereinafter, embodiments will be described in detail with reference to the accompanying drawings.

Embodiments of the present disclosure may, however, be embodied in many different forms and should not be construed as being limited to the embodiments set forth herein; rather, these embodiments are provided so that those skilled in the art thoroughly understand the present disclosure. Rather, these embodiments are provided so that this disclosure will be thorough and complete, and will fully convey the scope of the present disclosure to those skilled in the art.

In addition, in the following drawings, the thickness or size of each layer is exaggerated for convenience and clarity of description, and the same reference numerals in the drawings refer to the same elements. As used herein, the term “and/or” includes any and all combinations of one or more of the associated listed items. In this specification, it will also be understood that if a member A is referred to as being connected to a member B, the member A can be directly connected to the member B or indirectly connected to the member B with a member B therebetween.

The terms used in this specification are for illustrative purposes of the present disclosure only and should not be construed to limit the meaning or the scope of the present disclosure. As used in this specification, a singular form may, unless definitely indicating a particular case in terms of the context, include a plural form. Also, the expressions “comprise” and/or “comprising” used in this specification neither define the mentioned shapes, numbers, processes, operations, members, elements, and/or groups of these, nor exclude the presence or addition of one or more other different shapes, numbers, processes, operations, members, elements, and/or groups of these, or addition of these. The term “and/or” used herein includes any and all combinations of one or more of the associated listed items.

As used herein, terms such as “first,” “second,” etc. are used to describe various members, components, areas, layers, and/or portions. However, it is obvious that the members, components, areas, layers, and/or portions should not be defined by these terms. The terms do not mean a particular order, up and down, or superiority, and are used only for distinguishing one member, component, area, layer, or portion from another member, component, area, layer, or portion. Thus, a first member, component, area, layer, or portion which will be described may also refer to a second member, component, area, layer, or portion, without departing from the teaching of the present disclosure.

Spatially relative terms, such as “below”, “beneath”, “lower”, “above”, “upper” and the like, used herein for ease of description to describe one element or feature's relationship to another element(s) or feature(s) referring to the figures. These spatially relative terms are intended for easy comprehension of the prevent invention according to various process states or usage states of the prevent invention, and thus, the present disclosure is not limited thereto. For example, an element or feature shown in the drawings is turned inside out, the element or feature described as “beneath” or “below” may change into “above” or “upper”. Thus, the term “below” may encompass the term “above” or “below”.

Preferred embodiments of the present disclosure will be described in detail with reference to the accompanying drawings so that those skilled in the art can easily implement the present disclosure.

Here, throughout the specification, parts having similar configurations and operations are denoted by the same reference numerals. Also, in this specification below, when any portion is referred to as being “electrically connected” to another portion, it should be understood that the former can be “directly connected” to the latter, or “connected” to the latter via an intervening member.

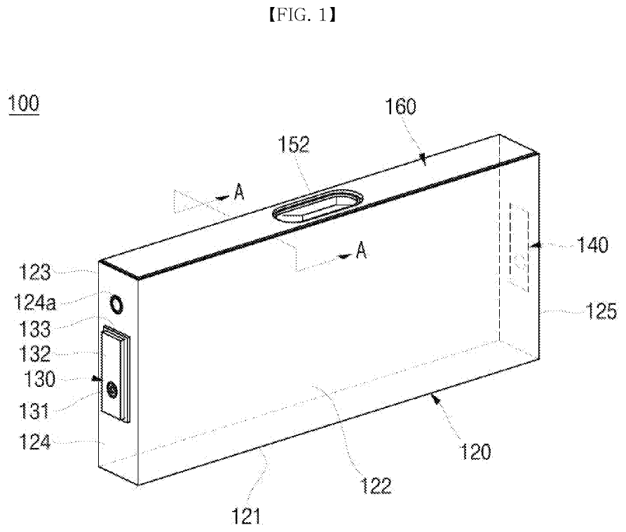

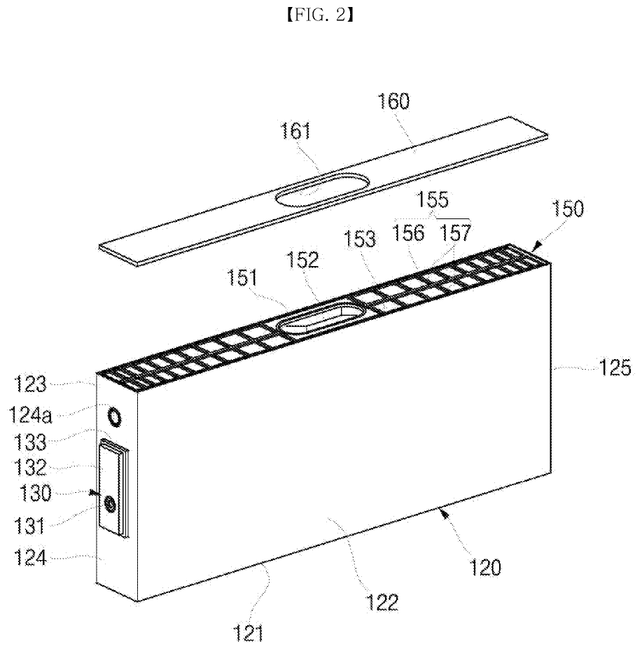

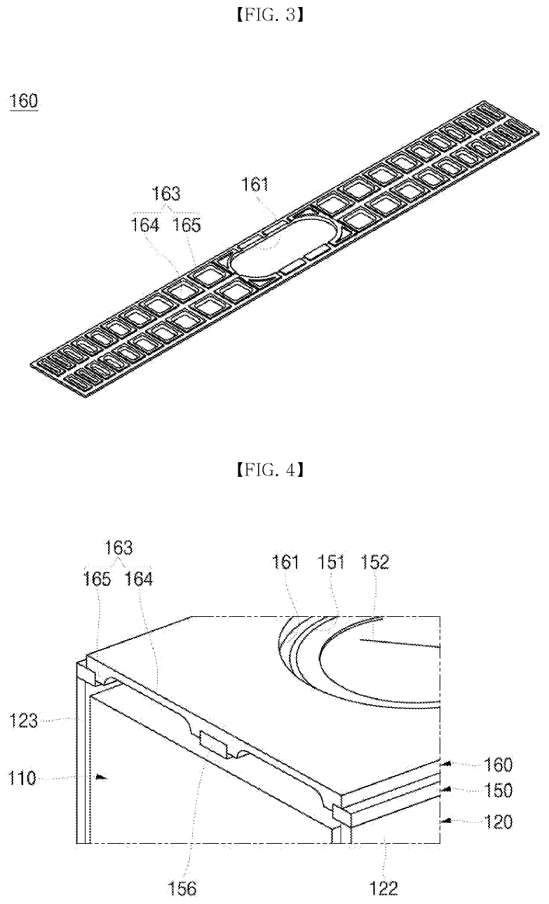

FIG. 1 illustrates a perspective view of a secondary battery according to embodiments of the present disclosure. FIG. 2 illustrates an exploded perspective view of the secondary battery according to embodiments of the present disclosure. FIG. 3 illustrates a perspective view of a bottom surface of a cover illustrated in FIG. 2. FIG. 4 illustrates a cross-sectional view taken along line A-A of FIG. 1.

Referring to FIGS. 1 and 2, a secondary battery 100 according to embodiments may include an electrode assembly 110, a case 120 accommodating the electrode assembly 110, a first terminal part 130, a second terminal part 140, a plate 150, and a cover 160.

The electrode assembly 110 may be provided by stacking or winding a stack of a thin plate-shaped or film-shaped first electrode plate, a separator, and a second electrode plate. In some embodiments, the electrode assembly 110 may be a stack type or a winding type electrode assembly. In some embodiments, the first electrode plate may serve as a positive electrode, and the second electrode plate may serve as a negative electrode. In some embodiments, the first electrode plate may serve as a negative electrode, and the second electrode plate may serve as a positive electrode.

In some embodiments, the first electrode plate may be provided by applying a first electrode active material such as transition metal oxide to a first electrode collector provided with metal foil such as aluminum or an aluminum alloy and may include a first electrode non-coating portion (or a first electrode tab) that is an area on which a first electrode active material is not applied. In some embodiments, the first electrode non-coating portion may be provided by being cut to protrude to one side and may be integrated with the first electrode plate. In some embodiments, approximately two first electrode non-coating portions may protrude in a lateral direction of the electrode assembly. In some embodiments, the first electrode non-coating portion may be provided on each of upper and lower portions of the electrode assembly.

In some embodiments, the second electrode plate may be provided by applying a second electrode active material such as graphite or carbon on a second electrode collector provided as metal foil such as copper, a copper alloy, nickel, or a nickel alloy and may include a second electrode non-coating portion (or a second electrode tab) that is an area on which a second electrode active material is not applied. In some embodiments, the second electrode non-coating portion may be provided by being cut to protrude in a lateral direction and may be integrated with the second electrode plate. In some embodiments, approximately two second electrode non-coating portions may protrude in a lateral direction of the electrode assembly 110. In some embodiments, the second electrode non-coating portion may be provided on each of upper and lower portions of the electrode assembly. In some embodiments, the protruding direction of the first electrode non-coating portion and the protruding direction of the second electrode non-coating portion may be opposite to each other.

In some embodiments, the separator may be disposed between the negative electrode plate and the positive electrode plate to prevent short circuit and enable movement of lithium ions and may include polyethylene, polypropylene, or a composite film of polyethylene and polypropylene. In some embodiments, the separator may be replaced with an inorganic solid electrolyte such as sulfide, oxide, or a phosphate compound, which does not require a liquid or gel electrolyte.

In some embodiments, the electrode assembly 110 may be accommodated in the case 120 together with the electrolyte. In some embodiments, the electrolyte may include an organic solvent such as ethylene carbonate (EC), propylene carbonate (PC), diethyl carbonate (DEC), ethylmethyl carbonate (EMC), or dimethyl carbonate (DMC), and lithium salt such as LiPF6 or LiBF4. In some embodiments, the electrolyte may be a liquid or a gel. In some embodiments, if an inorganic-based solid electrolyte is used, the electrolyte may be omitted.

The case 120 may be made of a conductive metal such as copper, nickel, aluminum, an aluminum alloy, or stainless steel. The case 120 may have a substantially hexahedral shape (e.g., a rectangular prism) having an opening into which the electrode assembly 110 is capable of being inserted and seated. For example, the case may include a bottom surface 121, a pair of long side surfaces 122 and 123 and a pair of short side surfaces 124 and 125, which extend upward from the bottom surface 121. As used herein, the long side surfaces 122 and 123 may refer to surfaces, each of which has an area relatively greater than that of each of the short side surfaces 124 and 125. In the drawing, the opening may be illustrated as being defined in the upper portion of the case 120, but if the case 120 is turned over, the opening may be defined in the lower portion of the case 120.

In some embodiments, the pair of short side surfaces 124 and 125 may be separated from the bottom surface 121 and the pair of long side surfaces 122 and 123. In some embodiments, the pair of short side surfaces 124 and 125 may be coupled to the bottom surface 121 and the pair of long side surfaces 122 and 123 by welding. In some embodiments, the pair of short side surfaces 124 and 125 may include a first short side surface 124 and a second short side surface 125. In some embodiments, the first short side surface 124 may be referred to as a first plate, and the second short side surface 125 may be referred to as a second plate. The first terminal part 130 may be coupled to the first short side surface 124, and the second terminal part 140 may be coupled to the second short side surface 125. In some embodiments, the first short side surface 124 may include an injection hole 124a for injecting the electrolyte. In some embodiments, a liquid injection stopper may be coupled to the injection hole 124a. In some embodiments, the plate 150 and the cover 160 may be coupled to the opening of the case 120 to seal the case 120.

The first terminal part 130 may be electrically connected to the first electrode plate of the electrode assembly 110. In some embodiments, the first terminal part 130 may include a rivet terminal 131 passing through the first short side surface 124, a terminal plate 132 coupled to the rivet terminal 131 at the outside of the first short side surface 124, and an insulating plate 133 disposed between each of the rivet terminal 131 and the terminal plate 132 and the first short side surface 124.

One end of the rivet terminal 131 may be electrically connected to the first electrode non-coating portion of a first collector plate, and the other end of the rivet terminal 131 may protrude to a side surface of the case 120 by passing through the first short side surface 124. In some embodiments, the rivet terminal 131 may be connected to the first electrode non-coating portion through a separate collector plate.

The terminal plate 132 may pass through the first short side surface 124 and be coupled to the rivet terminal 131 protruding to the side surface of the case 120. In some embodiments, after the terminal plate 132 is coupled to the rivet terminal 131, an end of the rivet terminal 131 may be fixed to the terminal plate 132 by riveting or welding.

The insulating plate 133 may be disposed between the terminal plate 132 and the first short side surface 124 to insulate the terminal plate 132 from the first short side surface 124. In some embodiments, the insulating plate 133 may extend between the rivet terminal 131 passing through the first short side surface 124 and the first short side surface 124 to insulate the rivet terminal 131 from the first short side surface 124.

The second terminal part 140 may be electrically connected to the second electrode plate of the electrode assembly 110. The second terminal part 140 may be electrically connected to the second electrode plate by passing through the second short side surface 125. The second terminal part 140 and the first terminal part 130 may be disposed in directions opposite to each other (e.g., the second terminal part 140 and the first terminal part 130 may be on opposite sides of the electrode assembly 110). Because a shape of the second terminal part 140 is the same as that of the first terminal part 130, a detailed description thereof will be omitted.

The plate 150 may be coupled to the case 120. The plate 150 may be made of the same material as the case 120. For example, the plate 150 may be made of aluminum. In some embodiments, the plate 150 may be coupled to case 120 by laser welding. In some embodiments, an edge of the plate 150 may be coupled to the pair of long side surfaces 122 and 123 and the pair of short side surfaces 124 and 125 of the case 120 by welding.

The plate 150 may include a vent hole 151, a plurality of gas discharge holes 153 defined outside the vent hole 151, and a rib 155 disposed between the plurality of gas discharge holes 153.

The vent hole 151 may be defined at an approximately center of the plate 150 and may be provided in an elliptical shape. A safety vent 152 may be coupled to the vent hole 151. The safety vent 152 may have a thickness less than that of the plate 150. The safety vent 152 may be ruptured if an internal pressure of the case 120 is greater than a set rupture pressure to discharge an internal gas, thereby preventing the secondary battery 100 from exploding.

The gas discharge hole 153 may be defined outside the vent hole 151. The gas discharge hole 153 may include a plurality of holes spaced apart from each other. Each of the gas discharge holes 153 may be provided in a rectangular shape. In some embodiments, a size of the gas discharge holes 153 may gradually decrease from a central portion toward the outside (i.e., toward the short side surfaces 124 and 125 of the case 120). Because the relatively thin safety vent 152 is ruptured by the internal gas, and the internal gas is directed toward the vent hole 151, the gas discharge hole 153 in the central portion is defined to be large so that the internal gas is easily discharged. The gas discharge hole 153 may be exposed to the outside if the cover 160 (to be described later) is melted by heat of the internal gas, which causes the internal gas to be discharged. In some embodiments, the plate 150 may have an effect of reducing costs and weight (lightening) due to the plurality of gas discharge holes 153.

The rib 155 may include a first rib 156 extending in a longitudinal direction of the plate 150 (i.e., a direction parallel to the long side surfaces 122 and 123 of the case 120) and a plurality of second ribs 157 perpendicular to the first rib 156 and extending from the first rib 156 toward the long side surfaces 122 and 123 of the case 120. In the illustrated embodiment, the first rib 156 and the plurality of second ribs 157 form a grid pattern. In some embodiments, the plurality of gas discharge holes 153 may be defined by the first rib 156 and the second ribs 157. The second ribs 157 may extend to both sides of the first rib 155, respectively. That is, the first rib 156 may extend along a central portion of the plate 150, and the second ribs 157 may extend from the first rib 156 toward the long side surface 122 and from the first rib 156 toward the long side surface 123. An interval between the second ribs 157 may become narrower from the vent hole 151 toward the short side surfaces 124 and 125 of the case 120. The rib 155 may serve as a net or framework that prevents the electrode assembly 110 from protruding to the outside so as to increase in temperature of the secondary battery or cause the short circuit after the cover 160 is melted by the internal gas.

The cover 160 may be coupled to the upper portion of the plate 150. The cover 160 may include an insulating material. For example, the cover 160 may include polyphenylene sulfide (PPS) having good chemical resistance and high rigidity. In some embodiments, the cover 160 may be integral with the plate 150 (e.g., the cover 160 and the plate 150 may be integrally formed by injection molding). In some embodiments, to facilitate the injection molding of the cover 160 and the plate 150, a surface treatment may be performed on a top surface of the plate 150. Due to this surface treatment, nano poles may be formed on the surface of the plate 150, and bonding strength with the cover 160 may increase. The cover 160 may cover the plurality of gas discharge holes 153 of the plate 150.

The cover 160 may include a center hole 161 defined in a center thereof. The center hole 161 may be defined at a position corresponding to the vent hole 151 of the plate 150. In some embodiments, the internal gas discharged through the vent hole 151 may be discharged to the outside through the center hole 161. The center hole 161 in the cover 160 may correspond to the size and shape of the vent hole 151 in the plate 150.

Referring to FIG. 3, the cover 160 may include a gas collection part 163 defined in a bottom surface thereof. The gas collection part 163 may be defined at a position corresponding to the gas discharge hole 153. In some embodiments, a plurality of gas collection parts 163 may be defined to correspond to the plurality of gas discharge holes 153 (e.g., the gas collection parts 163 may correspond to the size and shape of the gas discharge holes 153). The internal gas may be collected in the gas collection part 163. In some embodiments, the gas collection part 163 may have a size that decreases from the center hole 161 toward the outside (i.e., toward the short side surfaces 124 and 125 of the case).

Referring to FIGS. 3 and 4, the gas collection part 163 may include a base portion 164 and a protrusion 165 surrounding the base portion 164 and protruding from the base portion 164. The base portion 164 may have a thickness less than that of the cover 160. The base portion 164 may be concave upward from the bottom surface of the cover 160 so that a space in which the internal gas is collected is defined between the base portion 164 and the electrode assembly 110. The base portion 164 may be melted by the heat of the internal gas to expose the gas discharge hole 153 to the outside. In some embodiments, the internal gas generated in the secondary battery 100 may be primarily discharged to the outside through the vent hole 151 by rupturing the safety vent 152 and also be collected in the gas collection part 163, and the gas collected in the gas collection part 163 may be secondarily discharged through the gas discharge hole 153 by melting the base portion 164. The protrusion 165 may extend (at least partially) into the gas discharge hole 153.

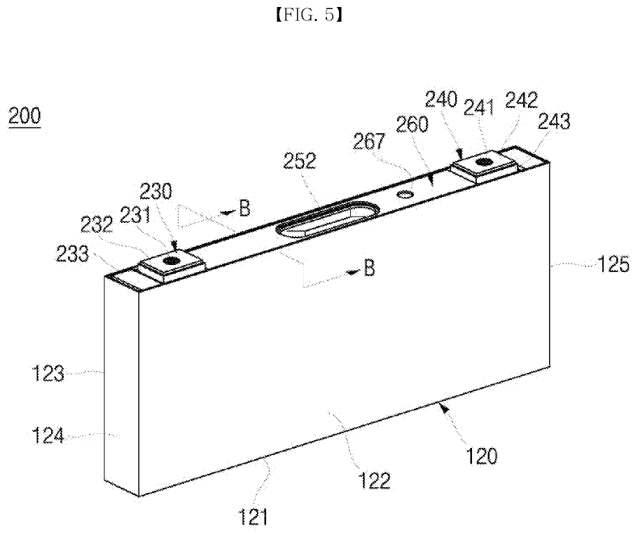

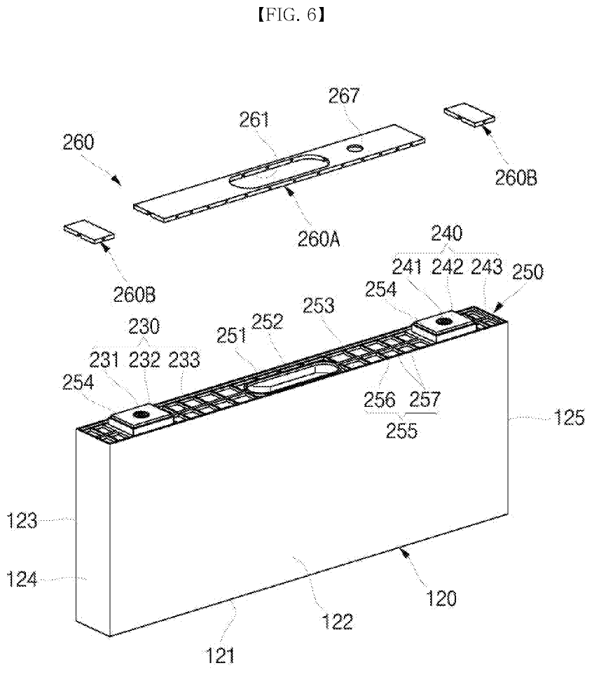

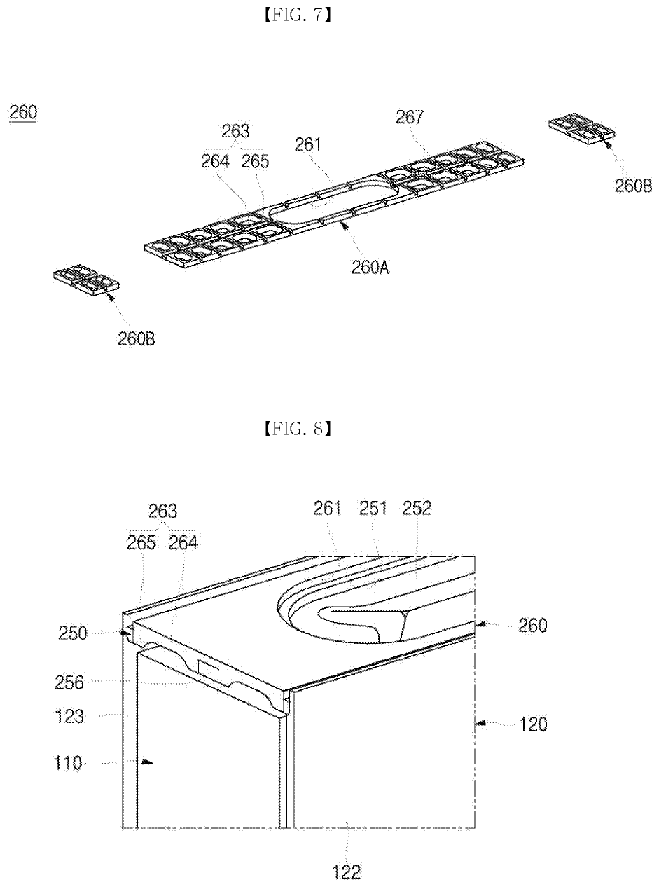

FIG. 5 illustrates a perspective view of a secondary battery according to other embodiments of the present disclosure. FIG. 6 illustrates an exploded perspective view of the secondary battery according to embodiments of the present disclosure. FIG. 7 illustrates a perspective view of a bottom surface of a cover illustrated in FIG. 6. FIG. 8 illustrates a cross-sectional view taken along line B-B of FIG. 5.

Referring to FIGS. 5 and 6, a secondary battery 200 according to embodiments may include an electrode assembly 110, a case 120 accommodating the electrode assembly 110, a first terminal part 230, a second terminal part 240, a plate 250, and a cover 260.

The first terminal part 230 may pass through the plate 250 and be electrically connected to the first electrode plate of the electrode assembly 110. The second terminal part 240 may pass through the plate 250 and be electrically connected to the second electrode plate of the electrode assembly 110. The first terminal part 230 may be located at one side of the plate 250, and the second terminal part 240 may be located at the other side of the plate 240.

In some embodiments, the first terminal part 230 may include a rivet terminal 231 passing through the plate 250, a terminal plate 232 coupled to the rivet terminal 231 at the outside of the plate 250, and an insulating plate 233 disposed between each of the rivet terminal 231 and the terminal plate 232 and the plate 250.

One end of the rivet terminal 231 may be electrically connected to the first electrode non-coating portion of a first collector plate, and the other end of the rivet terminal 131 may protrude to the plate 250 by passing through the plate 250. In some embodiments, the rivet terminal 231 may be connected to the first electrode non-coating portion through a separate collector plate.

The terminal plate 232 may pass through the plate 250 and be coupled to the rivet terminal 231 protruding to one side of the plate 250. In some embodiments, after the terminal plate 232 is coupled to the rivet terminal 231, an end of the rivet terminal 231 may be fixed to the terminal plate 232 by riveting or welding.

The insulating plate 233 may be disposed between the terminal plate 232 and the plate 250 to insulate the terminal plate 232 and the plate 250 from each other. In some embodiments, the insulating plate 233 may extend between the plate 250 and the rivet terminal 231 passing through the plate 250 to insulate the rivet terminal 231 from the plate 250.

In some embodiments, the second terminal part 240 may include a rivet terminal 241 passing through the plate 250, a terminal plate 242 coupled to the rivet terminal 241 at the outside of the plate 250, and an insulating plate 243 disposed between each of the rivet terminal 241 and the terminal plate 242 and the plate 250.

One end of the rivet terminal 241 may be electrically connected to the second electrode non-coating portion of the second collector plate, and the other end may protrude to the other side of the plate 250 by passing through the plate 250. In some embodiments, the rivet terminal 241 may be connected to the second electrode non-coating portion through a separate collector plate.

The terminal plate 242 may pass through the plate 250 and be coupled to the rivet terminal 241 protruding to the other side of the plate 250. In some embodiments, after the terminal plate 242 is coupled to the rivet terminal 241, an end of the rivet terminal 241 may be fixed to the terminal plate 242 by riveting or welding.

The insulating plate 243 may be disposed between the terminal plate 242 and the plate 250 to insulate the terminal plate 242 and the plate 250 from each other. In some embodiments, the insulating plate 243 may extend between the plate 250 and the rivet terminal 241 passing through the plate 250 to insulate the rivet terminal 241 from the plate 250.

The plate 250 may include a vent hole 251, a plurality of gas discharge holes 253 defined outside the vent hole 251, terminal holes 254 through which the first terminal part 230 and the second terminal part 240 pass, and a rib 255 disposed between the plurality of gas discharge holes 253. In some embodiments, because the vent hole 251, the gas discharge hole 253, and the rib 255 correspond to the vent hole 151, the gas discharge hole 153, and the rib 155, respectively, which are illustrated in FIG. 2, detailed description thereof will be omitted. The plate 250 may be seated on a stepped portion disposed on an inner surface of the case 120 and electrically connected to the case 120 by welding.

The terminal hole 254 may be defined at both sides of the vent hole 251. Each of the rivet terminal 231 of the first terminal part 230 and the rivet terminal 241 of the second terminal part 240 may be coupled to one of the terminal holes 254.

The cover 260 may be coupled to the plate 250 or may be integral with the plate 250 (e.g., by injection molding). The cover 260 may expose the first terminal part 230 and the second terminal part 240, which are coupled to the plate 250. The cover 260 may include a first area 260A disposed inside (between) the first terminal part 230 and the second terminal part 240, and a second area 260B disposed outside the first terminal part 230 and the second terminal part 240. In some embodiments, the second area 260B may be separated from the first area 260A and the second area 260B may be defined at both sides of the first area 260A.

The first area 260A of the cover 260 may include a central hole 261 corresponding to the vent hole 251 of the plate 250 (e.g., the central hole 261 may have a size and shape corresponding to the vent hole 251). In some embodiments, the first area 260A of the cover 260 may include a liquid injection hole 267 for injecting an electrolyte. In some embodiments, a liquid injection stopper may be coupled to the liquid injection hole 267. The electrolyte injected through the liquid injection hole 267 may be accommodated in the case 120 through the gas discharge hole 253 of the plate 250.

Referring to FIG. 7, the cover 260 may include a gas collection part 263 defined in a bottom surface thereof. The gas collection part 263 may be defined in each of both the first area 260A and the second area 260B of the cover 260. The gas collection part 263 may have a size that decreases from the center hole 261 toward the outside (i.e., toward the short side surfaces 124 and 125 of the case). In some embodiments, the gas collection part 263 of the first area 260A may have a size greater than that of the gas collection part 263 of the second area 260B. In one or more embodiments, the size and shape of the gas collection parts 263 may correspond to the size and shape of the gas discharge holes 253.

Referring to FIGS. 7 and 8, the gas collection part 263 may include a base portion 264 and a protrusion 265 surrounding the base portion 264 and protruding from the base portion 264. A space in which an internal gas is capable of being collected may be defined between the base portion 264 and the electrode assembly 110. The base portion 264 may be melted by heat of the internal gas to expose the gas discharge hole 253. In some embodiments, the internal gas generated in the secondary battery 200 may be primarily discharged to the outside through the vent hole 251 by rupturing the safety vent 252 and also be collected in the gas collection part 263, and the gas collected in the gas collection part 263 may be secondarily discharged through the gas discharge hole 253 by melting the base portion 264 and thereby exposing the gas discharge hole 253 to the outside. The protrusion 265 may extend (at least partially) into the gas discharge hole 253.

The secondary battery according to some embodiments may include the plate, in which the gas discharge hole is additionally defined outside the vent hole in which the safety vent is installed, and the cover that covers the opening of the plate to facilitate the discharge of the internal gas, thereby improving the safety.

In some embodiments, the secondary battery according to the embodiments may include the plate, in which the plurality of discharge holes are defined, to reduce the cost and the weight.

The above-mentioned embodiment is merely an embodiment of the secondary battery, and thus, the present invention is not limited to the foregoing embodiment, and also it will be understood by those of ordinary skill in the art that various changes in form and details may be made therein without departing from the spirit and scope of the present invention as defined by the following claims.

What is claimed is:

1. A secondary battery comprising:
an electrode assembly;
a case accommodating the electrode assembly and comprising an opening;
a plate coupled to the case at the opening, the plate comprising a vent hole and a safety vent in the vent hole; and
a cover coupled to the plate,
wherein the plate comprises a plurality of gas discharge holes outside of the vent hole.

2. The secondary battery as claimed in claim 1, wherein sizes of the plurality of gas discharge holes gradually increase in a direction outward away from the vent hole.

3. The secondary battery as claimed in claim 1, wherein the plate further comprises a rib between the plurality of gas discharge holes.

4. The secondary battery as claimed in claim 3, wherein the rib comprises:
a first rib extending in a longitudinal direction of the plate; and
a plurality of second ribs perpendicular to the first rib and extending from the first rib toward a long side surface of the case.

5. The secondary battery as claimed in claim 1, wherein the cover comprises an insulating material.

6. The secondary battery as claimed in claim 1, wherein the cover is integral with the plate.

7. The secondary battery as claimed in claim 1, wherein the cover comprises a center hole at a position corresponding to the vent hole.

8. The secondary battery as claimed in claim 1, wherein the cover comprises a gas collection part in a bottom surface of the cover.

9. The secondary battery as claimed in claim 8, wherein the gas collection part comprises:
a base portion; and
a protrusion protruding from the base portion.

10. The secondary battery as claimed in claim 9, wherein the base portion has a thickness less than the cover.

11. The secondary battery as claimed in claim 9, wherein the protrusion is coupled to the plurality of gas discharge holes.

12. The secondary battery as claimed in claim 1, further comprising:
a first terminal part electrically connected to a first electrode plate of the electrode assembly; and
a second terminal part electrically connected to a second electrode plate of the electrode assembly,
wherein the first terminal part is coupled to a first short side surface of the electrode assembly and the second terminal part is coupled to a second short side surface of the electrode assembly.

13. The secondary battery as claimed in claim 1, further comprising:
a first terminal part electrically connected to a first electrode plate of the electrode assembly; and
a second terminal part electrically connected to a second electrode plate of the electrode assembly,
wherein the first terminal part and the second terminal part are coupled to the plate.

14. The secondary battery as claimed in claim 13, wherein the cover comprises:
a first area inside the first terminal part and the second terminal part; and
a second area outside the first terminal part and the second terminal part and separated from the first area.
